(19) United States
(12) Patent Application Publication
(10) Pub. No.: US 2026/0152596 A1
(43) Pub. Date: Jun. 4, 2026

(54) Non-Ionic Hydrophilic Polyurethane Dispersions with Methacrylate Double Bonds

(71) Applicant: Covestro Deutschland AG, Leverkusen (DE)

(72) Inventors: Sebastian Doerr, Düsseldorf (DE); Petra Janssen, Kerken (DE); Michael Ludewig, Odenthal (DE); Ingo Gipperich, Leverkusen (DE)

(21) Appl. No.: 18/575,040

(22) PCT Filed: Jun. 27, 2022
(86) PCT No.: PCT/EP2022/067548

§ 371 Date: Dec. 28, 2023

(30) Foreign Application Priority Data
Jul. 1, 2021 (EP) 21183017.9

(51) Int. Cl. C08G 18/12; C03C 25/326; C08J 3/24; C08J 5/08

(52) U.S. Cl. CPC C08G 18/12; C03C 25/326; C08J 3/242; C08J 5/08; C08J 2475/14

(57) ABSTRACT

An aqueous UV-curable dispersion at least includes a reaction product composed of a) at least one polyisocyanate having an average isocyanate functionality of at least 2.2, of which preferably at least one polyisocyanate is an oligomeric polyisocyanate having urethane, biuret, allophanate, iminooxadiazinedione and/or isocyanurate structural units, b) at least one monohydroxy-functional compound containing methacryloyl groups, c) at least one component which contains non-ionically hydrophilic groups and has at least one further isocyanate-reactive group, and d) at least one diol, triol, diamine and/or triamine, the reaction product having no ionogenic or ionically hydrophilic groups.

### CROSS-REFERENCE TO RELATED APPLICATIONS

This application is the United States national phase of International Application No. PCT/EP2022/067548 filed Jun. 27, 2022, and claims priority to European Patent Application No. 21183017.9 filed Jul. 1, 2021, the disclosures of which are hereby incorporated by reference in their entireties.

### BACKGROUND

### Technical Field

The present invention relates to an aqueous UV-curable dispersion at least comprising a reaction product formed from a) at least one polyisocyanate having an average isocyanate functionality of at least 2.2, of which preferably at least one polyisocyanate is an oligomeric polyisocyanate having urethane, biuret, allophanate, iminooxadiazinedione and/or isocyanurate structural units, b) at least one monohydroxy-functional compound containing methacryloyl groups, c) at least one component that contains nonionically hydrophilizing groups and has at least one isocyanate-reactive group, and d) at least one diol, triol, diamine and/or triamine, the reaction product having no ionogenic or ionically hydrophilizing groups, to a process for the production thereof, to the use of the dispersion for producing glass fiber sizings, to a glass fiber sizing comprising at least one dispersion of this kind, to glass fibers provided with a sizing obtainable using a dispersion of this kind, to a process for producing glass-fiber-reinforced plastics, and to a corresponding glass-fiber-reinforced plastic.

### Description of Related Art

Aqueous coating agents based on functionalized polyisocyanates are known per se to those skilled in the art. They are for example combined into one-component coating agents and used for the coating of glass fibers, for glass fiber-reinforced plastics for example. After application to the glass fibers, the water is first removed. The resulting film, the so-called sizing, is crosslinked through reaction of the polyisocyanates latently present. Further crosslinking through reaction of the polyisocyanates present in the sizing then takes place when the glass fibers are incorporated into plastics.

Document EP 1 516 012 B1 discloses a glass fiber sizing composition comprising at least one water-dispersible or water-soluble blocked polyisocyanate (A), at least one polyurethane (B) containing groups polymerizable by free radicals, and an initiator (C) capable of initiating a free-radical polymerization.

Document DE 10 2009 008 949 A1 describes radiation-curable coating systems based on aqueous polyurethane dispersions comprising as structural components one or more oligomeric or polymeric compounds having at least one isocyanate-reactive group and at least one group copolymerizable by free radicals, optionally one or more monomeric compounds having a hydroxy function and at least one (meth)acrylate group, polyester polyols, optionally further polyols, one or more compounds having at least one isocyanate-reactive group and additionally ionic groups or groups capable of forming ionic groups or a combination of nonionic and ionic groups or groups capable of forming ionic groups that have a dispersant action on the polyurethane dispersion, and organic polyisocyanates.

The acrylate- or methacrylate-functional coating agents known from the prior art exhibit compatibility that is capable of improvement in typical formulations for glass fiber sizings that results for example in a significant shortening in processing time. A problem with the use of functional silanes in glass fiber sizings is that in typical glass fiber sizings the complex hydrolysis and condensation processes of the other constituents, in combination with functional silanes, often give rise to (intermediate) products that lead to unstable systems. No high-compatibility coating agents for glass fibers having (reactive) methacrylate groups have been described in the prior art.

### SUMMARY

An object of the present invention was therefore to provide a purely nonionically hydrophilized, functionalized polyisocyanate containing methacrylate groups, in particular for use as a glass fiber sizing, and a process for the production thereof. A further object of the present invention is to provide an aqueous dispersion of a corresponding polyisocyanate having sufficiently high storage stability.

According to the invention these objects are achieved by an aqueous UV-curable dispersion at least comprising a reaction product formed from
a) at least one polyisocyanate having an average isocyanate functionality of at least 2.2, of which preferably at least one polyisocyanate is an oligomeric polyisocyanate having urethane, biuret, allophanate, iminooxadiazinedione and/or isocyanurate structural units,
b) at least one monohydroxy-functional compound containing methacryloyl groups,
c) at least one component that contains nonionically hydrophilizing groups and has at least one isocyanate-reactive group,
d) at least one diol, triol, diamine and/or triamine, the at least one diol, triol, diamine and/or triamine preferably having a molecular weight of <400 g/mol,
   wherein the reaction product has no ionogenic or ionically hydrophilizing groups.

### DETAILED DESCRIPTION

The dispersions of the invention thus include a functionalized polyisocyanate that contains methacrylate groups polymerizable by high-energy radiation or by the addition of free-radical initiators such as peroxidic curing agents or azo-based curing agents and that no longer contains any free isocyanate groups.

The reaction product present in the UV-curable dispersion of the invention is obtained or is obtainable from the reaction of the following components:
35% to 75% by weight, particularly preferably 40% to 75% by weight, very particularly preferably 45% to 65% by weight, of component a),
10% to 50% by weight, particularly preferably 12% to 35% by weight, very particularly preferably 14% to 32% by weight, of component b),
5% to 40% by weight, particularly preferably 7% to 30% by weight, very particularly preferably 15% to 25% by weight, of component c), and
0.1% to 25% by weight, particularly preferably 0.1% to 9% by weight, very particularly preferably 0.1% to 5% by weight, of component d),
   wherein the percentages from a) to d) in each case add up to 100% by weight.

The dispersion of the invention may comprise auxiliaries and additives, for example those that permit or accelerate curing with high-energy radiation, such as electron beams or UV rays, or a free-radical reaction. In a preferred embodiment, the dispersion comprises stabilizers against premature curing, from the group comprising phenols, sterically hindered amines and/or thiazines.

The dispersion of the invention generally has an acid value of below 50 mg KOH/g polymer, preferably below 20 mg KOH/g polymer, particularly preferably below 10 mg KOH/g polymer, and particularly preferably below 5 mg KOH/g polymer. The acid value indicates the mass of potassium hydroxide in mg that is required to neutralize 1 g of the sample to be examined (measurement in accordance with DIN EN ISO 660 (2009 version)). The neutralized acids, i.e. the corresponding salts, do of course have a zero or reduced acid value. What is key here in accordance with the invention is the acid value of the corresponding free acid.

The dispersion of the invention generally has a zeta potential of −50 to +50 mV, preferably −15 to +15 mV, and particularly preferably −2 to +10 mV. The zeta potential is determined by measuring a sample diluted with demineralized water in a “ZetaSizer 3000HSA” (Malvern Instruments, Herrenberg, Germany) at 23° C.

The urethane group content (MW urethane group=59 g/mol) of the dispersion of the invention is generally 3% to 30% by weight, preferably 10% to 25% by weight, in each case based on the solids content.

As well as oligomeric polyisocyanates having preferably urethane, biuret, allophanate, iminooxadiazinedione and/or isocyanurate structural units, polyisocyanates a) suitable according to the invention are at least difunctional polyisocyanates such as cyclohexane 1,4-, 1,3-, and/or 1,2-diisocyanate, 1-methyl-2,4-diisocyanatocyclohexane, 1-methyl-2,6-diisocyanatocyclohexane, tetramethylene diisocyanate, octamethylene diisocyanate, decamethylene diisocyanate, dodecamethylene diisocyanate, H₆-2,4- and/or H₆-2,6-diisocyanatotoluene, 4,4′-diisocyanatodiphenylmethane, 2,4′-diisocyanatodiphenylmethane, 2,2′-diisocyanatodiphenylmethane, meta- and/or para-xylylene diisocyanate, 2,4-diisocyanatotoluene and/or 2,6-diisocyanatotoluene, isopropenyldimethyltolylene diisocyanate, α,α,α,′α,′-tetramethyl-m- and/or α,α,α,′α,′-tetramethyl-p-xylylene diisocyanate, hexamethylene 1,6-diisocyanate, trimethylhexane diisocyanate, tetramethylhexane diisocyanate, nonane triisocyanate, 1-isocyanato-3,3,5-trimethyl-5-isocyanatomethylcyclohexane (isophorone diisocyanate), 4,4′-diisocyanatodicyclohexylmethane and/or 2,4′-diisocyanatodicyclohexylmethane and/or 2,2′-diisocyanatodicyclohexylmethane, and mixtures of these diisocyanatodicyclohexylmethanes and mono- and dimethyl-substituted derivatives thereof and/or higher-functional reaction products, homologs, oligomers and/or polymers of the mentioned at least difunctional polyisocyanates having urethane, biuret, carbodiimide, isocyanurate, allophanate, iminooxadiazinedione and/or uretdione structural units. It is also possible to use a proportion of monofunctional isocyanates, such as stearyl isocyanate, butyl isocyanate, phenyl isocyanate or others such as 3-isocyanatopropyltrialkoxysilane.

The average isocyanate functionality of the polyisocyanate component a) is preferably 2.2 to 6, particularly preferably 2.4 to 5, very particularly preferably 2.6 to 4.5.

The polyisocyanate component a) preferably has a viscosity of less than 25 000 mPa·s at 23° C., particularly preferably of less than 15 000 mPa·s at 23° C.

The polyisocyanate component a) preferably consists to an extent of at least 40% by weight of oligomeric polyisocyanates based on hexamethylene diisocyanate that are liquid and have isocyanurate, biuret, uretdione, carbodiimide, allophanate and/or iminooxadiazinedione structural units and to an extent of not more than 60% by weight of isophorone diisocyanate, H₆-2,4- or H₆-2,6-tolylidene diisocyanate, hexamethylene 1,6-diisocyanate, 4,4′-diisocyanatodicyclohexylmethane and/or 2,4′-diisocyanatodicyclohexylmethane and/or 2,2′-diisocyanatodicyclohexylmethane and/or 2,4- or 2,6-tolylidene diisocyanate or reaction products thereof with trimethylolpropane, butanediol, ethylene glycol, diethylene glycol, propylene glycol or neopentyl glycol.

The polyisocyanate component a) particularly preferably consists to an extent of at least 70% by weight of oligomeric polyisocyanates based on hexamethylene diisocyanate and having biuret, iminooxadiazinedione, allophanate and/or isocyanurate structural units and to an extent of not more than 30% by weight of isophorone diisocyanate, 4,4′-diisocyanatodicyclohexylmethane and/or 2,4′-diisocyanatodicyclohexylmethane and/or 2,2′-diisocyanatodicyclohexylmethane and/or 2,4- or 2,6-tolylidene diisocyanate.

Suitable as component b) are compounds having monohydroxy-functional methacryloyl groups, such as hydroxyethyl methacrylate, 2-/3-hydroxypropyl methacrylate, hydroxybutyl methacrylate, 2-/3-/4-hydroxyethyl methacrylate, 2-/3-hydroxypropyl methacrylate, 2-/3-/4-hydroxybutyl methacrylate, ethoxylation and/or propoxylation products of said hydroxymethacrylates, reaction products of trimethylolpropane, glycerol and/or pentaerythritol or ethoxylation and/or propoxylation products thereof with 2 or 3 equivalents of methacrylic acid, reaction products of said hydroxymethacrylates with caprolactone, reaction products of monoepoxides such as Cardura® E10 (monoepoxide, Hexion Specialty Chemicals, the Netherlands) with methacrylic acid and mixtures of said compounds having monohydroxy-functional methacryloyl groups.

According to the invention, preference is given to using hydroxyethyl methacrylate, hydroxypropyl methacrylate and/or hydroxybutyl methacrylate as component b).

The dispersion of the invention additionally comprises at least one component c) that contains nonionically hydrophilizing groups and has at least one further isocyanate-reactive group. The component c) present according to the invention preferably has one or two, preferably one, isocyanate-reactive group and nonionically hydrophilizing structural units, preferably based on polyalkylene oxide.

Suitable as nonionically hydrophilizing component c) are, for example, polyoxyalkylene ethers containing at least one hydroxy or amino group. These polyethers contain a proportion of 30% by weight to 100% by weight of units derived from ethylene oxide. Useful compounds include polyethers of linear construction having a functionality of between 1 and 3, but also compounds of the general formula (I),

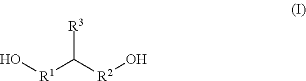

where
R¹ and R² are each independently a divalent aliphatic, cycloaliphatic or aromatic radical that has 1 to 18 carbon atoms and may be interrupted by oxygen and/or nitrogen atoms, and
R³ is an alkoxy-terminated polyethylene oxide radical.

Nonionically hydrophilizing compounds are, for example, also monovalent polyalkylene oxide polyether alcohols having a statistical average of 5 to 70 ethylene oxide units per molecule, as obtainable in a manner known per se by alkoxylation of suitable starter molecules, see for example Ullmanns Encyclopädie der technischen Chemie [Ullmann's Encyclopedia of Industrial Chemistry], 4th edition, volume 19, Verlag Chemie, Weinheim pages 31-38.

Examples of suitable starter molecules are saturated monoalcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyloxetane or tetrahydrofurfuryl alcohol, diethylene glycol monoalkyl ethers, for example diethylene glycol monobutyl ether, unsaturated alcohols such as allyl alcohol, 1,1-dimethylallyl alcohol or olein alcohol, aromatic alcohols such as phenol, the isomeric cresols or methoxyphenols, araliphatic alcohols such as benzyl alcohol, anisyl alcohol or cinnamyl alcohol, secondary monoamines such as dimethylamine, diethylamine, dipropylamine, diisopropylamine, dibutylamine, bis(2-ethylhexyl)amine, N-methyl- and N-ethylcyclohexylamine or dicyclohexylamine, and heterocyclic secondary amines such as morpholine, pyrrolidine, piperidine or 1H-pyrazole. Preferred starter molecules are saturated monoalcohols. Particular preference is given to using diethylene glycol monomethyl, monoethyl or monobutyl ether as the starter molecule.

Alkylene oxides suitable for the alkoxylation reaction are in particular ethylene oxide and propylene oxide, which may be used in the alkoxylation reaction in any order or else in a mixture.

The polyalkylene oxide polyether alcohols are either pure polyethylene oxide polyethers or mixed polyalkylene oxide polyethers in which the alkylene oxide units consist of ethylene oxide units to an extent of at least 30 mol %, preferably to an extent of at least 50 mol %.

Particularly preferred nonionic compounds c) are monohydroxy-functional polyalkylene oxide polyethers that contain at least 75 mol % of ethylene oxide units, particularly preferably 100 mol % of ethylene oxide units, and have a number-average molecular weight in the range from 350 to 2500 g/mol, particularly preferably in the range from 500 to 1100 g/mol, determined by gel-permeation chromatography (GPC) in accordance with DIN EN ISO 13885-2:2021, in N,N-dimethylacetamide as eluent at 23° C. with calibration using polystyrene standards.

The reaction product present in the dispersion of the invention has no ionogenic, i.e. potentially ionic, or ionically hydrophilizing groups. Preferably, the reaction product present in the dispersion of the invention has none of the ionogenic or ionically hydrophilizing groups or compounds mentioned below. Particularly preferably, the reaction product present in the dispersion of the invention has no ionically hydrophilizing groups, i.e. the following units are preferably not used in the reaction of a) to d):

Mono- and dihydroxycarboxylic acids, mono- and diaminocarboxylic acids, mono- and dihydroxysulfonic acids, mono- and diaminosulfonic acids and mono- and dihydroxyphosphonic acids or mono- and diaminophosphonic acids and salts thereof, such as dimethylolpropionic acid, dimethylolbutyric acid, hydroxypivalic acid, N-(2-aminoethyl)alanine, 2-(2-aminoethylamino)ethanesulfonic acid, ethylenediaminepropyl- or -butylsulfonic acid, propylene-1,2- or propylene-1,3-diamineethylsulfonic acid, malic acid, citric acid, glycolic acid, lactic acid, glycine, alanine, taurine, lysine, 3,5-diaminobenzoic acid, an addition product of IPDI and acrylic acid (EP-A 0 916 647, example 1) and the alkali metal and/or ammonium salts thereof; the adduct of sodium bisulfite to 2-butene-1,4-diol, polyethersulfonate, the propoxylated adduct of 2-butenediol and NaHSO₃, described for example in DE-A 2 446 440 (pages 5-9, formulas I-III), N-methyldiethanolamine, compounds that have carboxy or carboxylate and/or sulfonate groups and/or ammonium groups, in particular compounds that contain carboxyl and/or sulfonate groups as ionic or potentially ionic groups, such as the salts of 2-(2-aminoethylamino)ethanesulfonic acid or the addition product of diamines, such as ethylenediamine or isophoronediamine, and acrylic acid (EP-A 0 916 647, example 1) or of dimethylolpropionic acid.

In the context of the present invention, “no ionogenic or ionically hydrophilizing groups” means that in general, based on the reaction product present in the dispersion of the invention, no less than less is than 100 milliequivalents per 100 g of polyurethane polymer, preferably less than 25 milliequivalents, particularly preferably less than one milliequivalent and very particularly preferably less than 1 milliequivalent per 100 g of polymer, is present.

Components d) are diols, triols, diamines and/or triamines, the purpose of which is to extend the chain or to increase the molecular weight. The chain extension reaction between the amino groups and the isocyanate groups results in the formation of urea structural units in the polyurethane polyacrylate dispersions. It is optionally also possible to use proportions of hydroxyamines having only one amino group or monoamines, which then act as chain terminators.

Examples of components d) are ethylenediamine, propylene-1,3-diamine, hexamethylene-1,6-diamine, butane-1,4-diamine, hydrazine (hydrate), amino-functional polyethylene oxides or polypropylene oxides, which are obtainable for example under the name Jeffamine®, (from Huntsman Corp. Europe, Belgium), mono- or diamines containing alkoxysilane groups, diethylenetriamine, monoamines such as butylamine or diethylamine, triethylenetetramine, isophoronediamine, and hydroxyamines such as diethanolamine, hydroxyethylethylenediamine, and bishydroxyethylethylenediamine. Preference is given to linear aliphatic diamines such as ethylenediamine, hydrazine (hydrate) or hexamethylene-1,6-diamine and optionally aliphatic triamines such as diethylenetriamine.

If component d) is used according to the invention, it is used in an amount such that the degree of chain extension is 30 to 200%, preferably 50 to 150%, particularly preferably 70 to 110%.

The degree of chain extension is defined as the ratio of the amount of equivalents of amino groups in component d) to the amount of equivalents of isocyanate groups in the prepolymer A) that is obtained by reacting components a), b), and c). A degree of chain extension of 100% according to this definition is obtained when the amount of equivalents of amino groups in component d) corresponds exactly to the amount of equivalents of isocyanate groups in prepolymer A).

Examples of diols and triols that may be used are low-molecular-weight alcohols such as butanediol, hexanediol, neopentyl glycol, diethylene glycol, triethylene glycol, propylene glycol, dipropylene glycol, tetraethylene glycol and/or trimethylolpropane, ethoxylated and/or propoxylated diols and/or triols, based for example on diethylene glycol or trimethylolpropane, polycarbonate diols having a number-average molecular weight in the range from 700 to 2200 g/mol, polyether diols having a number-average molecular weight in the range from 400 to 2000 g/mol, polyester diols, alkyd resins containing unsaturated fatty acids and having a number-average molecular weight Mn in the range from 400 to 2000, and/or oligomers containing unsaturated groups, and/or hydroxy-functional and/or isocyanate-unreactive liquid polymers such as epoxy (meth)acrylates, ester (meth)acrylates, polyester (meth)acrylates, ether (meth)acrylates, polyether (meth)acrylates and/or urethane (meth)acrylates having a number-average molecular weight Mn in the range from 400 to 2000. Partial or complete incorporation into the polymer via the hydroxyl groups is possible. The number-average molecular weights are/were in each case determined in accordance with DIN EN ISO 13885-2:2021 by gel-permeation chromatography (GPC) in DMAc (N,N-dimethylacetamide) as eluent at 23° C., after calibration with polystyrene standards.

Oligoesters are obtained by esterification of carboxylic acids such as adipic acid, isophthalic acid, phthalic anhydride, maleic anhydride, fumaric acid, tetrahydrophthalic acid, hexahydrophthalic acid, dimer fatty acid, soybean oil fatty acid, benzoic acid and/or glutaric acid with alcohols such as neopentyl glycol, hexanediol, ethylene glycol, propylene glycol, butanediol, diethylene glycol, dipropylene glycol, cyclohexane-1,4-dimethanol, cyclohexane-1,4-diol, TCD diol, trimethylolpropane, glycerol and/or pentaerythritol.

Preference is given to using adipic acid, isophthalic acid, phthalic anhydride, tetrahydrophthalic anhydride and/or hexahydrophthalic anhydride with neopentyl glycol, ethylene glycol, diethylene glycol, glycerol and/or trimethylolpropane. Particular preference is given to using isophthalic acid and phthalic anhydride, optionally in combination with adipic acid and neopentyl glycol, optionally in combination with trimethylolpropane.

In a preferred embodiment, low-molecular-weight diols such as butanediol, hexanediol, neopentyl glycol, ethylene glycol, propylene glycol and/or polymer diols, such as polycarbonate diols or polyester diols, or epoxy acrylates, ester acrylates and/or polyester acrylates are used as component d).

In a further preferred embodiment, oligoesters having OH values of 240 to 500 mg KOH/g (determined in accordance with DIN EN ISO 4629-2:2016), preferably 300 to 500 mg KOH/g substance, and a number-average molecular weight Mw in the range from 200 to 400 g/mol, preferably in the range from 250 to 390 g/mol, are used as component d). The number-average molecular weights are/were in each case determined in accordance with DIN EN ISO 13885-2:2021 by gel-permeation chromatography (GPC) in DMAc (N,N-dimethylacetamide) as eluent at 23° C., after calibration with polystyrene standards.

In a preferred embodiment, component d) is selected from the group consisting of butanediol, hexanediol, neopentyl glycol, ethylene glycol, propylene glycol, ethylenediamine, isophoronediamine, hydrazine (hydrate), hexamethylene-1,6-diamine, diethylenetriamine and/or polymer diols, especially polycarbonate diols, polyester diols, epoxy acrylates, ester acrylates, and polyester acrylates, wherein the polymer diols preferably have a number-average molecular weight in the range from 700 to 2200 g/mol, as determined in accordance with DIN EN ISO 13885-2:2021 by gel-permeation chromatography (GPC) in DMAc (N,N-dimethylacetamide) as eluent at 23° C., after calibration with polystyrene standards, and wherein component d) is particularly preferably selected from the group consisting of butanediol, hexanediol, neopentyl glycol, ethylene glycol, propylene glycol, ethylenediamine, isophoronediamine, hydrazine (hydrate), hexamethylene-1,6-diamine and/or diethylenetriamine.

The dispersion of the invention may also be used as a mixture with other aqueous dispersions. These may be dispersions that also contain unsaturated groups, such as dispersions containing unsaturated, polymerizable groups based on polyesters, polyurethanes, polyepoxides, polyethers, polyamides, polysiloxanes, polycarbonates, polymers and/or polyacrylates.

It is also possible to admix dispersions, based for example on polyesters, polyurethanes, polyepoxides, polyethers, polyamides, polyvinyl esters, polyvinyl ethers, polysiloxanes, polycarbonates, polymers or polyacrylates, that contain functional groups such as alkoxysilane groups, hydroxy groups or isocyanate groups. For example, dual-cure systems can be produced that are curable via two different mechanisms.

The present invention also provides coating agents comprising the UV-curable polyisocyanate-based dispersions of the invention and crosslinkers based on amino resins and/or polyisocyanates and/or blocked polyisocyanates.

Suitable amino crosslinking resins are, for example, those based on melamine or urea. Suitable polyisocyanates are, for example, those mentioned under the description of a). Hydrophilizing agents suitable in principle for the polyisocyanates, such as those based on polyethers, are mentioned in the description of c). Examples of suitable blocking agents are methanol, ethanol, butanol, hexanol, benzyl alcohol, acetoxime, butanone oxime, caprolactam, phenol, diethyl malonate, diethyl malonate, dimethylpyrazole, triazole, dimethyltriazole, ethyl acetoacetate, diisopropylamine, dibutylamine, tert-butylbenzylamine, ethyl cyclopentanonecarboxylate, dicyclohexylamine and/or tert-butylisopropylamine.

It is also possible to admix dispersions based on polyesters, polyurethanes, polyepoxides, polyethers, polyamides, polysiloxanes, polyvinyl ethers, polybutadienes, polyisoprenes, chlorinated rubbers, polycarbonates, polyvinyl esters, polyvinyl chlorides, polymers or polyacrylates that have no functional groups.

Also suitable for combination with the dispersions of the invention can be what are known as reactive diluents—low-viscosity compounds having unsaturated groups—such as hexanediol bisacrylate, trimethylolpropane trisacrylate, trimethylolpropane diacrylate, pentaerythritol tetraacrylate, dipentaerythritol hexaacrylate or bisphenol A-based diepoxide bisacrylates. The present invention also provides binder combinations comprising the UV-curable polyisocyanate-based dispersions of the invention and one or more further dispersions.

The dispersion of the invention may also be used as a mixture with water-insoluble or water-dispersible oligomers or polymers containing unsaturated groups, wherein the water-insoluble or water-dispersible oligomers or polymers containing unsaturated groups are added to the dispersion of the invention prior to dispersion, the dispersions of the invention thereby serving as polymeric emulsifiers for these substances. Preferred mixtures are binder combinations comprising the dispersion of the invention and also water-insoluble or water-dispersible oligomers or polymers containing unsaturated groups.

The invention also provides a process for producing the dispersion of the invention, wherein an isocyanate-functional prepolymer A) is obtained by reacting components b) and c) in one or more reaction steps with an excess of component a), followed by the dispersing step through addition of water to form the prepolymer A) or transfer of the prepolymer A) to an aqueous receiver vessel, followed by a chain lengthening step through addition of component d).

The invention also provides a process for producing the dispersion of the invention, wherein an isocyanate-functional prepolymer A) is obtained by reacting components a), b) and c) in one or more reaction steps with an excess of component a), followed by a chain lengthening step through addition of component d), followed by the dispersing step through addition of water to form the prepolymer A) or transfer of the prepolymer A) to an aqueous receiver vessel.

The dispersions of the invention have solids contents (nonvolatile fractions) of generally 25% to 65% by weight, preferably 35% to 60% by weight.

In the processes of the invention, an organic solvent and/or a catalyst may be used in the production of the prepolymer A). Suitable catalysts for producing the prepolymers A) or the dispersions of the invention are in principle all those that catalyze the reaction of isocyanate groups with hydroxyl groups, for example tertiary amines, tin compounds, zinc compounds, zirconium compounds, copper compounds and/or bismuth compounds, preferably triethylamine, ethyldiisopropylamine, dimethylcyclohexylamine, N-methylmorpholine, 1,4-diazabicyclo [2.2.2]octane, tin dioctoate or dibutyltin dilaurate. Also suitable are salts of zinc, of titanium, and of molybdenum. Suitable amounts are, for example, 0.002% to 1% by weight, preferably 0.01% to 0.1% by weight. The reaction may also be carried out without the use of a catalyst.

The dispersions of the invention are generally produced at 20 to 150° C., preferably at 25 to 75° C.

In the process of the invention, component d) may be present diluted with water and/or organic solvents. The solvent optionally used can then be removed by distillation. Production without the use of solvents is possible, but production in organic solvents is preferred.

The dispersion of the invention generally contains less than 5% by weight, preferably less than 1% by weight, and particularly preferably less than 0.5% by weight, of organic solvents.

Preference is given to production in 3% to 50% by weight of acetone (nonvolatile fraction of the acetone solution), particularly preferably in 5% to 25% by weight of acetone, with subsequent distillative removal of solvent after production of the dispersion or during the dispersing step.

Suitable solvents are in principle all solvents or solvent mixtures that do not react with the reaction components, for example N-butylpyrrolidone, butyl acetate, ethyl acetate, methoxypropyl acetate, diethylene glycol dimethyl ether, dioxane, dimethylformamide, xylene, toluene, solvent naphtha, cyclohexanone, methyl isobutyl ketone, diethyl ketone, methyl ethyl ketone, and acetone. Some of these solvents can then be completely or partly removed by distillation. After the dispersion of the invention has been produced, it is also possible to add further solvents, for example hydroxy-functional solvents such as butyl diglycol, methoxypropanol or butyl glycol.

The dispersion of the invention may be used to produce glass fiber sizings.

The present invention therefore relates also to the use of the dispersion of the invention for producing glass fiber sizings.

The present invention relates also to the glass fiber sizing comprising at least one dispersion of the invention.

The present invention relates also to glass fibers provided with a sizing obtainable using the dispersion of the invention.

A glass fiber sizing generally comprises the dispersion of the invention, optionally at least one binder, and optionally auxiliaries and additives.

To produce the aqueous sizing composition, the constituents present are preferably mixed one after the other in any order or simultaneously.

The preferably aqueous glass fiber sizing of the invention may optionally comprise further binders, for example polyurethane dispersions, polyacrylate dispersions, polyurethane-polyacrylate hybrid dispersions, polyvinyl ether or polyvinyl ester dispersions, polystyrene or polyacrylonitrile dispersions, including in combination with other blocked polyisocyanates and amino crosslinking resins such as melamine resins. In a preferred embodiment, no further binders are used other than the dispersion of the invention.

The glass fiber sizing of the invention may comprise the customary auxiliaries and additives, such as defoamers, thickeners, leveling agents, dispersants, catalysts, anti-skinning agents, anti-settling agents, antioxidants, plasticizers, reactive diluents, emulsifiers, biocides, adhesion promoters, for example based on known low- or high-molecular-weight silanes, lubricants, wetting agents, antistats.

Adhesion promoters used are for example known silane adhesion promoters such as 3-aminopropyltrimethoxysilane or triethoxysilane, N-(2-aminoethyl)-3-aminopropyltrimethoxysilane, 3-glycidylpropyltrimethoxysilane, vinyltrimethoxysilane, vinyltriethoxysilane or 3-methacryloxypropyltriethoxysilane. The concentration of the silane adhesion promoters in the glass fiber sizing of the invention is preferably 0.05% to 2% by weight, particularly preferably 0.15% to 0.85% by weight, in each case based on the total sizing.

The glass fiber sizing of the invention may comprise one or more nonionic and/or ionic lubricants, which may be selected for example from the following groups of substances: polyalkylene glycol ethers of fatty alcohols or fatty amines, polyalkylene glycol ethers and glycerol esters of fatty acids having 12 to 18 carbon atoms, polyalkylene glycols, higher fatty acid amides having 12 to 18 carbon atoms of polyalkylene glycols and/or alkylene amines, quaternary nitrogen compounds, for example ethoxylated imidazolinium salts, mineral oils, and waxes. The lubricant(s) is/are preferably used in a total concentration of 0.05% to 1.5% by weight based on the total glass fiber sizing.

The glass fiber sizing of the invention may comprise one or more antistats, such as lithium chloride, ammonium chloride, Cr(III) salts, organic titanium compounds, arylalkyl sulfates or sulfonates, aryl polyglycol ether sulfonates or quaternary nitrogen compounds. The antistats are preferably used in concentrations of 0.01% to 0.8% by weight based on the total glass fiber sizing.

In addition, the glass fiber sizing of the invention may optionally additionally comprise further auxiliaries and additives known from the prior art, such as those described in K. L. Loewenstein “The Manufacturing Technology of Continuous Glass Fibres”, Elsevier Scientific Publishing Corp., Amsterdam, London, New York, 1983.

The glass fiber sizing of the invention may be produced by the methods known per se. For example, a suitable mixing vessel is charged with about half of the total water needed and the binder, the curing agent, and then the lubricant and other customary auxiliaries, if used, are added while stirring. The pH is then adjusted to preferably 5 to 7 and a hydrolyzate of an adhesion promoter, for example of a trialkoxysilane, produced according to the instructions of the manufacturer (for example UCC, New York) is then added.

After a further stirring time of, for example, 15 minutes the sizing is ready for use; if necessary, the pH is adjusted further to 5 to 7.

The glass fiber sizing may be applied to the glass fiber by any desired method, for example using suitable devices such as spray or roller applicators.

Suitable glass fibers are both the known types of glass used for glass fiber production, such as type E, A, C, and S glass, and other products known per se from glass fiber manufacturers. Preference is given to type E glass fibers, which are employed for the production of continuous glass fibers on account of their absence of alkali, high tensile strength, and high modulus of elasticity for the reinforcement of plastics.

The production process, the process for the sizing treatment, and the reprocessing of the glass fibers is known and described for example in K. L. Loewenstein “The Manufacturing Technology of Continuous Glass Fibres”, Elsevier Scientific Publishing Corp., Amsterdam, London, New York, 1983.

The glass fiber sizing is customarily applied to the glass filaments drawn from spinnerets at high speed immediately after they have solidified, i.e. before winding. However, it is also possible for the fibers to undergo sizing treatment in an immersion bath after the spinning process. The sizing-treated glass fibers may be processed into cut glass for example, which may be done either wet or dry. The proportion of the sizing, based on the sizing-treated glass fibers, is preferably 0.1% to 5.0% by weight, particularly preferably 0.1% to 3.0% by weight, and very particularly preferably 0.3% to 1.5% by weight.

In one variant, the sizing-treated glass fiber is dried in several stages: first, water and any solvent present are removed from the sizing by heat, convection, thermal radiation and/or dehumidified air. This is then followed by curing through UV irradiation. The customary prior art irradiation devices are used. Preference is given to high- or medium-pressure mercury lamps, which may optionally be doped with elements such as gallium or iron. It can also be useful to combine a plurality of irradiation devices one after the other, next to one another or in any desired three-dimensional arrangements. It may also be expedient to carry out the UV irradiation at elevated temperatures, at from 30 to 200° C.

In another variant, the sizing-treated glass fiber undergoes essentially physical drying: water and any solvent present are removed from the sizing by heat, convection, thermal radiation and/or dehumidified air, with the result that the methacrylate groups present mostly do not react in this stage, but remain as methacrylate groups. This variant is preferred.

The sizing-treated glass fibers can then be incorporated into matrix polymers. A large number of thermoplastics or thermosetting polymers may be used as matrix polymers. Examples of suitable thermoplastic polymers are: polyolefins such as polyethylene or polypropylene, polyvinyl chloride, polymers such as styrene/acrylonitrile copolymers, ABS, polymethacrylate or polyoxymethylene, aromatic and/or aliphatic polyamides such as polyamide 6 or polyamide 6,6, polycondensates such as polycarbonate, polyethylene terephthalate, liquid-crystalline polyaryl esters, polyarylene oxide, polysulfone, polyarylene sulfide, polyarylsulfone, polyethersulfone, polyarylether or polyetherketone or polyadducts such as polyurethanes. Thermosetting polymers include for example: epoxy resins, unsaturated polyester resins, vinyl resins, acrylate-functional resins, methacrylate-functional resins, phenolic resins, amine resins, polyurethane resins, polyisocyanurates, epoxy/isocyanurate combination resins, furan resins, cyanurate resins, and bismaleimide resins. Incorporation into the polymer matrix may be effected according to the generally customary methods known to those skilled in the art (for example extrusion). In a preferred variant, the uncured matrix units contain groups having double bonds, for example allyl groups, vinyl groups, acrylate groups, olefinic groups or methacrylate groups. These then preferably undergo curing, initiated for example by UV light, electron beams, heat, free-radical initiators or a combination of the methods mentioned. Curing can be effected according to the generally customary methods known to those skilled in the art.

The present invention relates also to a process for producing glass-fiber-reinforced plastics, comprising at least the following steps:
(A) applying the glass fiber sizing of the invention to glass fibers in order to obtain sizing-treated glass fibers,
(B) introducing the sizing-treated glass fibers into a plastic matrix, and
(C) at least partially chemically reacting methacrylate groups of the glass fiber sizing with the groups of the plastic matrix with the formation of covalent bonds so as to obtain the glass-fiber-reinforced plastic.

Suitable plastics have already been mentioned further above. Process parameters such as temperature, pressure, suitable devices, etc. are known per se to those skilled in the art.

The present invention is elucidated by way of examples.

### Example

### Chemicals Used:

Desmodur® Ultra N 3300 Isocyanurate based on hexamethylene diisocyanate, Covestro Deutschland AG, Leverkusen, DE

The other chemicals were unless otherwise stated obtained from Sigma-Aldrich Chemie GmbH, Taufkirchen, Germany.

Unless differently stated, all percentages are percent by weight (% by weight).

Unless differently stated, all analytical measurements were carried out at a temperature of 23° C.

The reported viscosities were determined by rotary viscometry in accordance with DIN 53019-2008 at 23° C. using a rotary viscometer from Anton Paar Germany GmbH, Ostfildern, Germany.

NCO contents were unless explicitly otherwise stated determined volumetrically in accordance with DIN-EN ISO 11909-2007.

The reported particle sizes were determined by laser correlation spectroscopy (instrument: Malvern Zetasizer 1000, Malvern Inst. Limited) after dilution of the sample with demineralized water.

Solids contents were determined by heating a weighed sample to 120° C. At constant weight, the solids content was calculated by reweighing the sample.

Monitoring for free NCO groups was carried out by IR spectroscopy (band at 2260 cm⁻¹).

As a storage test, 250 ml samples of the dispersion were stored at room temperature and at 40° C. The samples were monitored visually for the formation of sediment. Samples with sediment were judged to be unstable.

All molecular weights or molar masses mentioned in this application are unless otherwise stated defined by gel-permeation chromatography (GPC) in accordance with DIN EN ISO 13885-2:2021, in DMAc (N,N-dimethylacetamide) as eluent at 23° C., with calibration using polystyrene standards.

OH values (hydroxyl values) are determined/defined in accordance with DIN EN ISO 4629-2:2016.

### Inventive Example

### DSB 9705—HEMA-Functionalized Crosslinker

A standard stirring apparatus was charged. charged with 1261 g of Desmodur Ultra N 3300, 0.9 g of tin(II) chloride, 0.05 g of phenothiazine, and 0.5 g of BHT in 240 g of acetone and heated to 50° C. 660 g of 2-hydroxyethyl methacrylate was then slowly added to the solution and the mixture allowed to react in boiling acetone for 5 hours.

470 g of methoxypolyethylene glycol having a number-average molar mass of 750 g/mol and 26 g of butane-1,4-diol were then added and the mixture was stirred while boiling until isocyanate groups were no longer detectable by IR spectroscopy.

2960 g of deionized water was then added with vigorous stirring and the acetone was distilled off at 40° C. under reduced pressure.

The resulting dispersion had the following properties:
Solids content: approx. 44% by weight
pH: approx. 3.5
Viscosity approx. 110 mPa·s
Average particle size (LCS): 124 nm

The dispersion was stable to storage at room temperature and at 40° C. for at least 4 weeks. No phase separation developed during this time.

### Example Formulation of a Glass Fiber Sizing

To examine the basic suitability in general glass fiber sizings, an example formulation was produced in accordance with the table below and stored at room temperature for 12 days.

### Example Formulation:

| Starting material | Mass [g] |
|---|---|
| Water (demineralized) | 229.3 |
| Dispersion from inventive example | 15.0 |
| Acetic acid (60% by weight in water) | 0.5 |
| Polyvinylpyrrolidone 40000 (20% by weight in water) | 2.5 |
| 3-(Trimethoxysilyl)propyl methacrylate | 1.3 |
| 3-(2-Aminoethylamino)propyltrimethoxysilane | 1.5 |

Observation: No changes in viscosity and no phase separation were observed over the course of 12 days at room temperature.

1. An aqueous UV-curable dispersion at least comprising a reaction product formed from
a) at least one polyisocyanate having an average isocyanate functionality of at least 2.2, of which at least one polyisocyanate is an oligomeric polyisocyanate having urethane, biuret, allophanate, iminooxadiazinedione and/or isocyanurate structural units,
b) at least one monohydroxy-functional compound containing methacryloyl groups,
c) at least one component that contains nonionically hydrophilizing groups and has at least one isocyanate-reactive group,
d) at least one diol, triol, diamine and/or triamine, the at least one diol, triol, diamine and/or triamine having a molecular weight of <400 g/mol,
wherein the reaction product has no ionogenic or ionically hydrophilizing groups.

2. The dispersion as claimed in claim 1, wherein the reaction product is obtained from the reaction of the following components:
a) 35% to 75% by weight of component a),
b) 10% to 50% by weight of component b),
c) 5% to 40% by weight of component c), and
d) 0.1% to 25% by weight of component d),
wherein the percentages from a) to d) in each case add up to 100% by weight.

3. The dispersion as claimed in claim 1, wherein the polyisocyanate component a) consists to an extent of at least 40% by weight of oligomeric polyisocyanates based on hexamethylene diisocyanate that are liquid at room temperature and have isocyanurate, biuret, uretdione, carbodiimide and/or iminooxadiazinedione structural units and to an extent of not more than 60% by weight of isophorone diisocyanate, H₆-2,4- or H₆-2,6-tolylidene diisocyanate, hexamethylene 1,6-diisocyanate, 4,4′-diisocyanatodicyclohexylmethane and/or 2,4′-diisocyanatodicyclohexylmethane and/or 2,2′-diisocyanatodicyclohexylmethane and/or 2,4- or 2,6-tolylidene diisocyanate or reaction products thereof with trimethylolpropane, butanediol, ethylene glycol, diethylene glycol, propylene glycol or neopentyl glycol.

4. The dispersion as claimed in claim 1, wherein the polyisocyanate component a) consists to an extent of at least 70% by weight of oligomeric polyisocyanates based on hexamethylene diisocyanate and having biuret, iminooxadiazinedione and/or isocyanurate structural units and to an extent of not more than 30% by weight of isophorone diisocyanate, 4,4′-diisocyanatodicyclohexylmethane and/or 2,4′-diisocyanatodicyclohexylmethane and/or 2,2′-diisocyanatodicyclohexylmethane and/or 2,4- or 2,6-tolylidene diisocyanate.

5. The dispersion as claimed in claim 1, containing 0.5% to 40% by weight of component e).

6. The dispersion as claimed in claim 1, wherein at least one monohydroxy-functional polyalkylene oxide polyether having a molecular weight of 500 to 1100 g/mol is used as component c).

7. The dispersion as claimed in claim 1, wherein component d) is used in amounts such that a degree of chain elongation is 100 to 200%.

8. The dispersion as claimed in claim 1, comprising an acid value of below 50 mg KOH/g polymer (measurement according to EN ISO 660 (2009 version)).

9. The dispersion as claimed in claim 1, wherein component d) is selected from the group consisting of butanediol, hexanediol, neopentyl glycol, ethylene glycol, propylene glycol, ethylenediamine, isophoronediamine, hydrazine (hydrate), hexamethylene-1,6-diamine, diethylenetriamine and/or polymer diols, wherein the polymer diols have a number-average molecular weight in the range from 700 to 2200 g/mol, determined by gel-permeation chromatography (GPC) in accordance with DIN EN ISO 13885-2:2021 in N,N-dimethylacetamide as eluent at 23° C., with calibration using polystyrene standards.

10. A process for producing the dispersion as claimed in claim 1, wherein an isocyanate-functional prepolymer A) is obtained by reacting components a), b) and c) in one or more reaction steps with an excess of component a), followed by a chain lengthening step through addition of component d), followed by a dispersing step through addition of water to form the prepolymer A) or transfer of the prepolymer A) to an aqueous receiver vessel.

11. A process for producing the dispersion as claimed in claim 1, wherein an isocyanate-functional prepolymer A) is obtained by reacting components b) and c) in one or more reaction steps with an excess of component a), followed by a dispersing step through addition of water to form the prepolymer A) or transfer of the prepolymer A) to an aqueous receiver vessel, followed by a chain lengthening step through addition of component d).

12. A method for producing glass fiber sizings comprising providing a dispersion as claimed in claim 1.

13. A glass fiber sizing at least comprising a dispersion as claimed in claim 1.

14. A glass fiber provided with a sizing obtainable using a dispersion as claimed in claim 1.

15. A process for producing glass-fiber-reinforced plastics, comprising at least the following steps:
(A) applying a glass fiber sizing as claimed in claim 13 to glass fibers to obtain sizing-treated glass fibers,
(B) introducing the sizing-treated glass fibers into a plastic matrix, and
(C) at least partially chemically reacting methacrylate groups of the glass fiber sizing with the groups of the plastic matrix with the formation of covalent bonds so as to obtain the glass-fiber-reinforced plastic.

16. A glass-fiber-reinforced plastic comprising glass fibers as claimed in claim 14.

17. A glass-fiber-reinforced plastic comprising glass fibers that have undergone sizing treatment with a glass fiber sizing as claimed in claim 13.
